(19) United States
(12) Patent Application Publication
(10) Pub. No.: US 2006/0047643 A1
(43) Pub. Date: Mar. 2, 2006

(54) Method and system for a personalized search engine

(76) Inventor: Chirag Chaman, New York, NY (US)

Correspondence Address: DARA L ONOFRIO;ONOFRIO LAW, 1133 BROADWAY, SUITE 1600, NEW YORK, NY, 10010, US

(21) Appl. No.: 11/214,006

(22) Filed: Aug. 29, 2005

Related U.S. Application Data
(60) Provisional application No. 60/605,723, filed on Aug. 31, 2004.

(51) Int. Cl. G06F 17/30

(52) U.S. Cl. 707/3

(57) ABSTRACT

A system for personalization of searches comprising a network which is accessible by one or more users; a search engine which locates a result set of documents in response to a search query by a user; a personalization engine which pre-processes said search query to return a personalized result set. A network-based search engine database configured to store data which is ranked according to usage, the data being searchable by a search engine; and a method for personalization of searches using the database to return a personalized result set of documents to a user.

This application claims the benefit of U.S. provisional application No. 60/605,723 filed Aug. 31, 2004, which is incorporated herein by reference.

### FIELD OF THE INVENTION

The present invention provides a method to score documents considered relevant to a search query and a particular entity, such as a user, by ranking a set of documents considered relevant to the search query using a set of root documents considered relevant to the entity. More particularly, the invention provides an easy method and system to combine entities into groups, and optionally expanding the personalization of search results of the entity over the group.

### BACKGROUND OF THE INVENTION

The Internet is filled with content that is growing by millions of pages a day. As the information on the Internet grows exponentially, it has becomes harder and harder to find personalized information. These days, getting the “desired” results from a search engine has become an art—users can no longer simply type a one or two word query and get the results they are looking for. The users must refine or expand their query to find the results that meet their needs.

The present invention applies technology that was developed to better target and optimizes advertisements shown on web pages not only by matching keywords, but also by gaining some understanding about the user to the Internet. The invention thereby allows users to personalize their searches and get the results that they are most likely to be interested in.

The first step in creating a personalized search experience is to get an understanding of the user's interests. Moreover, to make this understanding universal, it had to be done in a way that overcame language barriers—so that a user in China, Japan or Morocco has the same user experience irrespective of which language they type their search query in. Another important step in getting users the desired information was to create a system to distinguish good information from the not-so-good information. While content and link based analysis are good measures for removing bad pages, nothing is better than having users collectively decide which page is good or bad. This collective usage analysis further improves the results provided by the invention.

The invention provides searches that caters to the user's specific searching needs and provides results that are needed. Users are inundated with search engines that flood them with too much information, produce irrelevant results, or “trick” them into selecting links to buy a new product or service. Most of the results user's get today from searches are generic and do not reflect any of the users personal preferences.

The invention takes a new route to search offering users the power of the web, coupled with individualized criteria. The invention lets the user, enhance the power of their search in the following ways:
Providing content that matters to users by leveraging “active” content, content which is current and relevant to the users interests;
Leveraging search results that the user may have viewed in the past;
Predicting users responses; and
Collaborating and extending search interests with those of user's friends and colleagues.

The invention search technology allows the user to search pages that are most frequently accessed and offer up-to-date, useful information. Current search engines predominantly rank pages that are based on a link index. Thus, they crawl and index pages that may or may not be important simply because another page links to them. While some link based ranking algorithms do separate the good pages from the not-so-good pages, search spam is a lingering problem.

Search engines in use today, as described in the paper “The Anatomy of a Large-Scale Hyper-textual Web Search Engine” rank documents largely based on the documents themselves and their relation to other documents (The Anatomy of a Large-Scale Hypertextual Web Search Engine, S. Brin & L. Page, http://www-db.stanford.edu/˜backrub/google.html). They do not personalize the results for each and every user. The primary advantage of the invention is the ability to personalize the result set returned by a search engine in response to a search query.

The invention provides a network-based search engine database for searches which is created by taking all the pages visited by users, imported via RSS feeds, and imported from other know sources of good information, and analyzing their usage and link relationship. The majority of pages in here are “active”, i.e. they are being actively seen by users across an organization, a group, a geographic location or all over the world and contain useful information. Pages that have not been accessed in some time, or are not of high quality, will be removed from the database in due course.

Pages are ranked based on the “F-Rank”, which is a ranking algorithm that takes into account link analysis, importance, time-based usage, and relevance of the page. A weighted average of these various scoring components is computed, giving pages that have been recently accessed a higher weight. As time goes by the pages lose their score unless visited by the user or other users—this ensures that important pages that people see on the Web are kept fresh in the index. As the F-Rank of a page is computed multiple times every hour, the user gets the most relevant, important, popular and recent results matching their search query.

The invention provides a method to compute a Root Set of documents relevant both to the entity and the search query and present the entity with a result set that is personalized.

Another advantage of the invention is that it provides a relatively easy method to create groups of users to expand the search over. By combining a set of entities in a group and computing the Root Set and Extended Set across all the users in the Group the results can be re-ranked or personalized based on the documents present in the group. The grouping can be done manually by a user or automatically by (a) considering users from the same organization, geographic location, etc. (b) considering entities that have similar documents in their Root or Extended Set or in another embodiment by looking at the latent relationship (using Latent Semantic Indexing or Singular Vector Decomposition) between the documents and/or between the Users and documents seen by each user.

The invention also provides a searchable archive of all the documents previously seen or bookmarked by the users. This archive is not stored on the user's computer but at an external location, thereby allowing the user to search thru their previously seen documents from any computer by logging in to the external location.

### SUMMARY OF THE INVENTION

The invention provides a system for personalization of searches comprising a network which is accessible by one or more users; a search engine which locates a result set of documents in response to a search query by a user; a personalization engine which pre-processes said search query to return a personalized result set.

In another embodiment, the personalization engine adds information to said query to personalize it by the user. If desired by the user, the personalization engine filters or re-ranks said result set of documents located by the search engine.

The following components are also part of the invention system. An entity index which keeps track of all documents relevant to the user and a document tracker which collects information via access logs and data feeds including documents visited, client/user identifiers, date, time and links within the documents visited, to compute a score for relevance.

An expert document index which stores scores from the document tracker based on access and usage information of all users collectively.

A document relationship index which stores information on the relationship between documents located in response to said search query.

A personalization object index which creates a personalization object for each user. The personalization object index comprises a root set which is the set of all documents relevant to the user and an extended set which is computed for the user by obtaining all documents related or linked to the root set from the document relationship index.

A document classification index which contains information on which class or category a document resides in.

The invention also includes a method for personalization of searches comprising maintaining a network-based search engine database configured to store data which is relevant to a search query by a user; sending a search query by the user to the search engine using a computer network; returning a result set of documents relevant to the search query; forwarding the result set of documents to a personalization engine for personalization processing of said documents; and returning a personalized result set of documents to the user.

In another embodiment the personalization processing further comprises adding information to the search query and sending the modified query to said search engine.

The user is assigned client/user identifiers which are stored in an entity index. This entity index tracks all documents relevant to said user and/or client. Depending on the desire of the user, documents in the result set are either a set of documents which have been seen by the user or a set of documents which have not been seen by the user.

In general, each document is given a score computed on the access and usage information of the document by the user. A document tracker collects information via access logs and data feeds including documents visited, client/user identifiers, date, time and links within the documents visited, to compute the score. The expert document index stores scores from the document tracker based on access and usage information of all users collectively.

The entity index further comprises bookmarks, web histories and manual entries of hyper-links relevant to an entity. The entity can be a user, a group, a category or a geographic location.

The invention also provides a network-based search engine database configured to store data which is ranked according to usage, the data being searchable by a search engine. The data is ranked according to link analysis, importance, time-based usage and relevance of the page. This ranking is computed multiple times per hour.

Other objects, features and advantages of the present invention will be apparent when the detailed description of the preferred embodiments of the invention are considered with reference to the drawings, which should be construed in an illustrative and not limiting sense as follows:

### BRIEF DESCRIPTION OF THE DRAWINGS

FIG. 1 illustrates the system and process according to the invention;

FIG. 2 illustrates the system and process for creating a personal web space; and

FIG. 3 is a flow chart describing the retrieval of documents using the computation data for creating the personal web space.

### DETAILED DESCRIPTION OF THE INVENTION

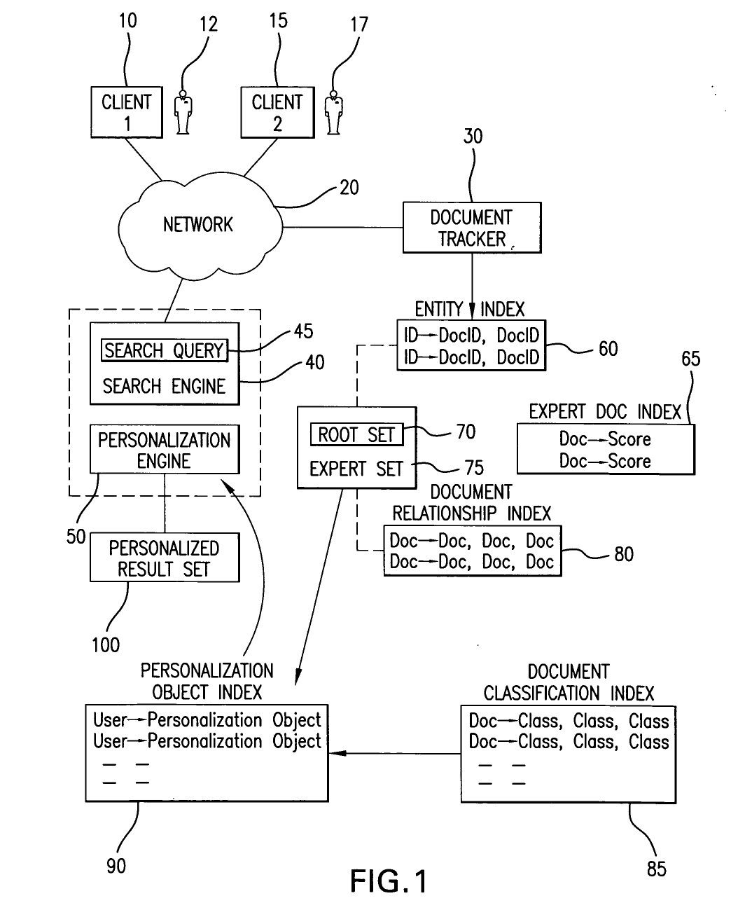

The following are the main components of the system and method of the invention as illustrated in FIG. 1.
10—Client 1
15—Client 2
20—Network
30—Document Tracker
40—Search Engine
45—Search Query
50—Personalization Engine
60—Entity Index
65—Expert Document Index
70—Root Set
75—Extended Set
80—Document Relationship Index
85—Document Categorization Index
90—Personalization Object Index
100—Personalized Result Set

In general, the term network means at least two computers linked together, as such the internet is considered a form of a network. Accordingly, as used in the specification herein, unless specified otherwise, the terms network and internet are used interchangeably.

FIG. 1 illustrates the general embodiment of the invention. The Clients 10, 15 are computer devices being used by Users 12, 15 accessing the search engine 40 over a network 20. Each User is assigned an identifier (ID). The Entity Index 60 keeps track of all the documents relevant to a User and/or Client. In this embodiment we deem relevant to be the set of documents previously seen by a user (the entity). In another embodiment it can be the set of documents not desired by an entity. Each Document is given a score we call “MyRank”—the higher the score, the more relevant the document. The score is computed using access and usage information of the document by the user. This information is gathered with the help of the Document Tracker 30. The Document Tracker collects the following information via access logs, manual addition by a user or data feeds consisting of one or more of the following components—Document accessed, entity ID, Date, Time, length of access, and any action user may have taken, for example, a click on a hyperlink, if the document has a hyperlink within.

Each document is assigned an “Expert Score” which is computed by based on access and usage information of all the users collectively, which we call “GroupRank” and is stored in the Expert Document Index 65. This document is optional and is used to refine the Document Relationship Index 80.

The Document Relationship Index stores information on how documents are related to one another. In this embodiment these are the hyperlinks linking one document to another. The links are refined, i.e. bad links removed by selecting only those links that meet a threshold score as stored by the Expert Doc Index 65.

The Root Set 70 is the set of all document deemed relevant to the user. The system optionally computes an Extended Set 75 for the user by getting all the documents that are related or linked to the Root Set by getting the information from the Document Relationship Index.

The Personalization Object Index 90, creates a personalization object for each entity. The Personalization Object is comprised of the Root Set and Extended Set of the User and refreshes it on a periodic basis. This optional component therefore caches the personalization object to improve the speed of the system. The Personalization Object optionally stores the classification or aggregate categories of the Root Set and/or Extended Set documents by querying the Document Classification Index 85. The Document Classification Index contains information on which class or category a document resides in. For instance, a document such as www.cnn.com/europe/headlines.htm can be classified as “News” and “Region→Europe”.

The Search Query 45, is a query issued to the Search Engine 40, by a user. The Personalization Engine 50 pre-processes the Search Query and optionally adds information to the query to personalize it. It can optionally re-rank or filter the results returned by the Search Engine to personalize them.

Operation:

The User 12 send a Search Query 45 to the search Engine 40. The Search Engine sends the query to the Personalization Engine 50 for “personalization processing”, which ads information to the search query to aid in personalization. The Personalization Engine 50 achieves this by getting the Personalization Object from the Personalization Object Index 90 and encoding all the available information, such as the Root Set, Expert Set, and Classification in the Search Query.

The Personalization Engine sends the modified query to the Search Engine which returns a Personalized Result Set 100 to this user. These are the documents considered relevant to the search query and the user.

In an alternate embodiment the Search Query can be executed in its original form in the Search Engine and the resulting result set is sent to the Personalization Server for processing which in turn returns a Personalized Result Set.

In another embodiment the invention also allows users to create a repository of documents that they have visited using a web browser, referred to as a “Personal Web” space, whereby the documents are reverse-indexed and stored in a centralized location for document retrieval. Each document is stored with access data statistics of each visit of each document for each user.

This embodiment allows the users to search within their own personal web space for a document they have visited in the past, and also allows users to search within the personal web spaces of other users

The embodiment identifies a plurality of documents based on the search query received by a user and ranks the documents based on the popularity of the document within the user's web space, combined with the popularity of the document amongst all the other users. The popularity score is computed based on the statistics computed for each pair of document visited by each user.

This gives users the ability to store all or any of the web pages they have visited automatically, and have a central location where they can search for information within these documents from any computer with Internet access, for easy and fast retrieval. In addition, it gives the user the ability to rank a list of relevant documents returned for the search based on the popularity and perceived usefulness of the document by other users or by the user's own browsing habits—such as number of visits made to that page, time spent on that page, recency of visit, etc.

Unlike current search engines that have a static rank assigned to the documents returned for a search query, the invention gives a dynamic rank that is different for each user.

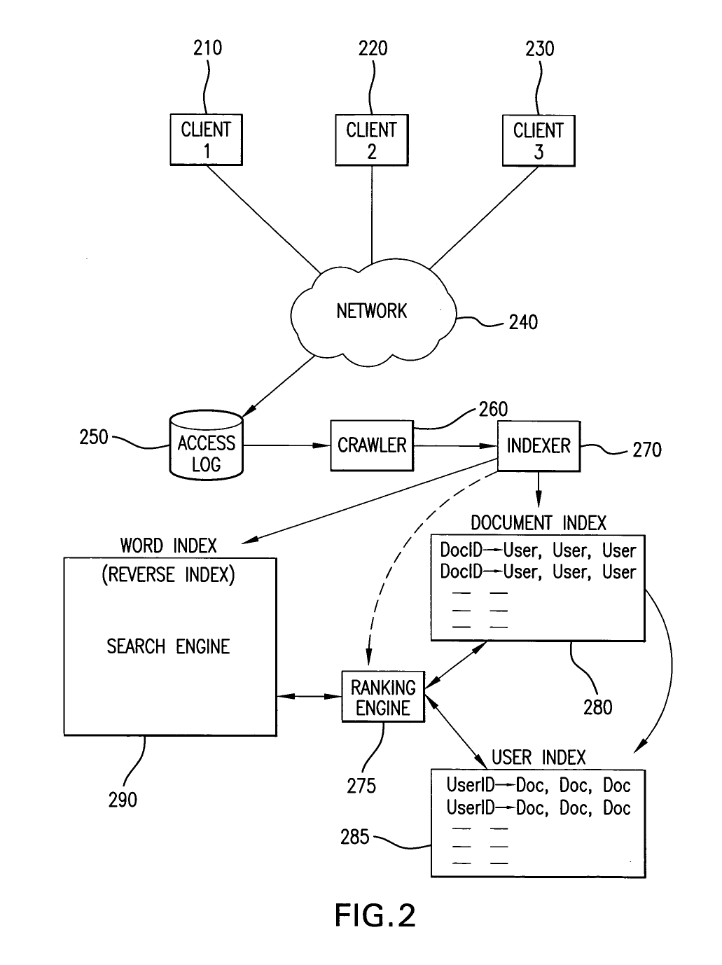

FIG. 2 illustrates the personal web space embodiment. The Clients, 210, 220, 230 are software applications, such as a browser plug-in or desktop application, or devices capable of recording the current website a user is on and relays that information over the network 240, to a computer server that stores the information about the current Website and a unique user ID assigned to each user using the Clients to an Access Log 50.

The Crawler 260, reads the URL visited by each user and fetches the data from the Internet and stores it in a repository giving each document a unique Doc ID. The Indexer 270 reads the crawlers repository 260, for each page that was crawled, gets the list of corresponding User IDs from the Access Log 250, and stores the information in multiple computer data structures in the following manner:

a. The Indexer takes words from each document and stores them in the Word Index 90, such that the words of the document point to the Doc ID they are in. The Indexer consults the Ranking Engine 275, to see if any words or documents need to be given special treatment while ranking. The Ranking Engine 275 is a collection of rules and processes that are used to compute statistics on the collected data.

b. The Indexer 270, also stores all the Users that visited a Doc ID (Document) in the Document Index 280, along with the date/time of the visit, time spent on the document, whether the user clicked any links in the document and whether the user tagged the document for saving or organizing, and whether the user ranked the document on a ranking scale which can be a feature in the Client software.

c. The Indexer stores all the documents visited by a User ID (User) in the User Index 285, along with a single score called “My Rank”, for each document, which represent the importance and popularity of that document for the user.

The Ranking Engine 275, is a process that can be triggered either by the Indexer or run on a time based schedule, and computes raw data points of document usage and popularity of the documents, namely—the number of times a user visited a document during a time period, date/time of visit, length of visit, number of days a user visited a document in the time period. The Ranking Engine then computes the “My Rank” value for each Doc ID, User ID combination. The process that computes the My Rank value takes as its input details about the previous visits to the document by the user and a decay factor—the decay factor gives higher importance to new data as it reduces the importance of older data. The Ranking engine also pre-computes and stores values in aggregate form about the document access data and stores it in the Document Index. This aggregate data in used by the Ranking Engine to compute the “Group Rank” during the document retrieval phase.

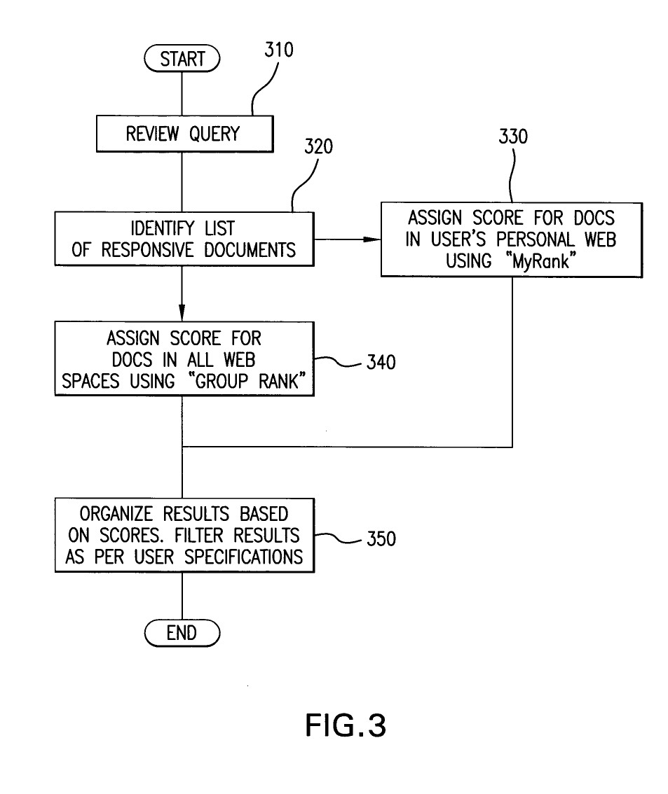

During the document retrieval process described in FIG. 3 the Ranking Engine uses the raw data points above collectively for all users, combined with the score given to each word in the Word Index, 90 to calculated a score called the “Group Rank” for each document.

FIG. 3 illustrates the process of retrieving documents using the invention described in FIG. 2. A user sends a search query that is reviewed 310, for errors and re-constructed with the User ID of the user. The modified query is used to identify the list of documents that satisfy the query utilizing the Word Index and the User Index. The process then splits into two separate processes—one that calculates the scores for each document visited by the user and matching the query terms using the “My Rank” score 330, and the other process computes a score for all the documents using the “Group Rank” score 340. The documents are that organized for display to the user 350, taking into account any specification or preference the user may have, e.g. color, adult filters, etc.

A user would either install the client software on the device used to access the Internet, of the device is equipped with such a software that sends the location or URL and accompanying information of the website or URL, that the user is currently visiting. The accompanying information may contain, the User ID for the user, an identifier for the Client software, and date/time.

The information sent by the client is received by a server and stored in the Access Log. The Crawler fetches the content of page visited by the user and the Indexer stores that information is such a manner that gives the user the ability search for that page by using any word or combination of words that are in that page. This creates a “Personal Web” space for each user. The invention stores all the web spaces of each as one gigantic web spaces while maintaining the individuality or each Personal Web.

The user can then search his or her own Personal Web and the Personal Webs of other users by issuing a search query either on a web site or via the Client software. The user is returned a list of results which can be shown as a whole sorted by the score, or shown as two separate result lists, sorted by the “My Rank” score and the “Group Rank” score.

Other components of the invention system are as follows:

WebCache. The WebCache is a secure, web-enabled archive of all users visited webpages. It is an index of all sites visited by the user and is stored in the users secure personal web space. This index can then be searched, making it extremely easy to find pages that the user visited earlier in the day or months ago. Since the WebCache is stored in the user's personal web space, it is accessible for searching from any computer on which user can log into the network.

WebMarks. WebMarks are a user's portable favorites that are accessible from anywhere and act as a considerably enhanced favorites list. Unlike a bookmarks list found in IE or Firefox, WebMarks are accessible anywhere the user can log into the network. WebMarks are easy to search, and allows users to attach Tags and Notes. These two features further simplify finding information. Finally, it possible to share a user's WebMarks through an RSS feed or a JavaScript script, or search other user's WebMarks through Contacts and Groups.

Tags and Notes. Every WebMark can store and modify relevant tags and notes. Tags allow the user to group together WebMarks based on a common theme or category. This can be used to limit searches to specific categories. Searches can span, and WebMarks can be associated with, multiple tags, allowing the user to create highly efficient searches. Notes allow user to add a short, searchable description of each WebMark and can help user find WebMarks.

Contacts and Groups. Contacts are useful for viewing other user's WebMarks. A user can add a contact if the username or e-mail address is known. Once the user has built a contact list, the user can either search or view the WebMarks of users contacts. They can also see who has listed the user as a contact. Creating a group of contacts allows the user to put contacts with similar interests together, making it possible to search related WebMarks.

The present invention will be illustrated in more detail by the following examples without limiting the scope of the invention in any way.

### EXAMPLE 1

Jane wants to know the latest on the “Live 8 concerts” being held. She does a search according to the invention and the highest ranked content matching her query is returned. These results are ranked based on the importance, usage and popularity of content containing her keywords. As the ranking is recomputed multiple times an hour, new popular pages will move up the ranking ladder fast. If Jane only wanted to see the pages she has not read before, she can check the “Hide pages I have seen” box which is located on the toolbar, and only the new pages that she has not seen will be displayed.

### EXAMPLE 2

George is interested in buying a new MP3 player and also happens to be a frequent visitor to Amazon.com. He performs a search according to the invention to get information on MP3 players. The results of his query is personalized and will show Amazon.com as a returned link because Amazon.com is a place he has been to before and Amazon sells MP3 players.

In addition, pages that contain similar information to pages that George has seen regarding MP3 players will also get a higher rank. If for instance, he has been researching MP3 players for a few days, and primarily interested in players from iRiver. When a Personalized Search is done, other pages on the Web that contain information about iRiver MP3 players are shown to him even for a generic query like “MP3 players”.

George can also control the degree of his personalization, from no personalization, to “Medium”, to “High” level of personalization. This will cause results from previous sites that George has visited and contain information on MP3 to get a higher rank.

### EXAMPLE 3

Jim is an avid investor, frequenting Yahoo! Finance multiple times a day to check on the stock market. He wants to know the latest news on Oracle and does an ActiveWeb search. With personalization set to off, Jim will see more results from oracle.com as they are a better match to the query. With personalization set to medium or high, Jim might see news articles from Forbes or Yahoo! Finance that talk about Oracle as these are article that are most popular and active about Oracle currently.

### EXAMPLE 4

Sonia is looking to buy a new Land Rover, and visits a few automobile sites to do research. A few hours later she does an ActiveWeb search for “Land Rover” and is shown results from other automotive sites that also list information on Land Rovers (as opposed to news articles or pages on non-automotive sites).

A couple of days later, Sonia searches on “Insurance”. The search engine makes a guess that she's interested in automobile insurance, instead of another insurance product, and gives a boost to the ranking of those pages, showing them higher up on the results.

In general, a users WebCache, WebMarks and Tags and Notes can be used in searches according to the invention. The search results can be sorted by relevance, personal score, or some combination thereof.

The foregoing description of various and preferred embodiments of the present invention has been provided for purposes of illustration only. The invention now being fully described, it will be apparent to one of ordinary skill in the art that many changes and modifications can be made thereto without departing from the spirit and scope of the invention as set forth herein and in the following claims.

What is claimed is:

1. A system for personalization of searches comprising:
a network which is accessible by one or more users;
a search engine which locates a result set of documents in response to a search query by a user;
a personalization engine which pre-processes said search query to return a personalized result set.

2. The system according to claim 1 wherein said personalization engine adds information to said query to personalize it by said user.

3. The system according to claim 1, wherein said personalization engine filters or re-ranks said result set of documents located by said search engine.

4. The system according to claim 1, further comprising an entity index which keeps track of all documents relevant to said user and a document tracker which collects information via access logs and data feeds including documents visited, client/user identifiers, date, time and links within the documents visited, to compute a score for relevance.

5. The system according to claim 4, further comprising an expert document index which stores scores from said document tracker based on access and usage information of all users collectively.

6. The system according to claim 1, further comprising a document relationship index which stores information on the relationship between documents located in response to said search query.

7. The system according to claim 1, further comprising a personalization object index which creates a personalization object for each user.

8. The system according to claim 7, wherein said personalization object index comprises a root set which is the set of all documents relevant to said user and an extended set which is computed for said user by obtaining all documents related or linked to said root set from said document relationship index.

9. The system according to claim 8, further comprising a document classification index which contains information on which class or category a document resides in.

10. A method for personalization of searches comprising:
maintaining a network-based search engine database configured to store data which is relevant to a search query by a user;
sending a search query by said user to said search engine using a computer network;
returning a result set of documents relevant to said search query;
forwarding said result set of documents to a personalization engine for personalization processing of said documents; and
returning a personalized result set of documents to said user.

11. The method according to claim 10, wherein said personalization processing further comprises adding information to said search query and sending the modified query to said search engine.

12. The method according to claim 10, wherein said user is assigned client/user identifiers which are stored in an entity index; wherein said entity index further tracks all documents relevant to said user and/or client.

13. The method according to claim 10, wherein said documents are either a set of documents which have been seen by said user or a set of documents which have not been seen by said user.

14. The method according to claim 10, wherein each document is given a score computed on the access and usage information of the document by said user.

15. The method according to claim 14, wherein a document tracker collects information via access logs and data feeds including documents visited, client/user identifiers, date, time and links within the documents visited, to compute said score.

16. The method according to claim 12, wherein said entity index further comprises bookmarks, web histories and manual entries of hyper-links relevant to an entity, wherein said entity is a user, a group, a category or a geographic location.

17. The method according to claim 15, wherein an expert document index stores scores from said document tracker based on access and usage information of all users collectively.

18. A network-based search engine database configured to store data which is ranked according to usage, the data being searchable by a search engine.

19. The database according to claim 18, wherein said data is ranked according to link analysis, importance, time-based usage and relevance of the page.

20. The database according to claim 18, wherein said ranking is computed multiple times per hour.
